(19) United States
(12) Patent Application Publication
(10) Pub. No.: US 2015/0347536 A1
(43) Pub. Date: Dec. 3, 2015

(54) Systems and Methods for Generating Contextual Insight on Electronic Devices

(71) Applicant: Christopher Cornelius Smith, New York (NY)

(72) Inventor: Christopher Cornelius Smith, New York (NY)

(21) Appl. No.: 14/724,797

(22) Filed: May 28, 2015

Related U.S. Application Data
(60) Provisional application No. 62/003,727, filed on May 28, 2014.

(51) Int. Cl. G06F 17/30; G06Q 50/00; H04L 29/06

(52) U.S. Cl. CPC G06F 17/30554; H04L 65/403; G06Q 50/01; G06F 17/30241

(57) ABSTRACT

A method, device, system, and computer program product relating to social media and ecommerce, including a generation of contextual insight available for viewing and updating via at least one electronic device. An example embodiment provides users with actionable insights based on impactful events that have occurred, are occurring, or are expected to occur, in the proximity of the user's location of interest. The system computes the potential impact of the occurrence of these events on the user's specific goals at the time of inquiry. The system can notify a shop owner of events that might impact foot traffic by their shop and suggest ways to mitigate potential revenue loss. The system can notify a traveler of recent interrelated events and suggest that a particular street/route or neighborhood in a city should be avoided.

### REFERENCE TO APPLICATIONS

This application claims priority to U.S. Provisional Patent Application Ser. No. 62/003,727, entitled “Systems and Methods for Generating Contextual Insight on Electronic Devices,” filed on May 28, 2015, the disclosure of which is incorporated herein in its entirety by reference thereto.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### FIELD

A method, device, system, and computer program product that generally relates to social media and ecommerce; and more particularly relates to a contextual view or information access method, device, system, and computer program product, accessible on an electronic handheld device or other electronic device.

### RELATED INFORMATION

At any given time, external events occur that can in positive, neutral, and negative ways, and to varying degrees and for varying time periods, impact the activities ongoing in the area proximate to where they occur. The impacts of these events are contextually dependent (e.g., when they occur, where they occur, and the activity of the particular user experiencing their impact) and interdependent. For example, certain events are more, less, and/or differently impactful in the presence or absences of other events.

Having advance and/or present notice of these events and/or understanding their interactions, probabilities and potential impacts allows for proactive response to leverage or mitigate them. For example, store owners or managers that are quickly made aware of a customer report of unsanitary conditions against their place of business can take corrective action before the situation becomes worse and costs them more money from fines or lost business. For example, prior knowledge of sidewalk or street closures that will significantly reduce foot or vehicle traffic by their shop can allow managers or store owners time to appropriately allocate staff and resources in line with expected customer levels.

Such data may be disparate, unwieldy to access, or unavailable to the general public or those who may be impacted by such. Further, obtaining access and/or understanding the effect of such information often requires particular skills or education to meaningfully merge, analyze, synthesize, and extract actionable insights. As a result, there exists a real need to provide such information and analysis to others, in a dynamic manner.

### SUMMARY

Embodiments of the present invention provide for a novel social media and/or contextual view of information system, method, device, and computer program product.

Embodiments of the present invention provide for generating and providing contextual insight on electronic, mobile, handheld, standalone, networked, or other devices. Embodiments of the present invention provide for a system and method for generating and providing insights to a user, based on a location and the nature of the user's past, present and projected, future activities in, around, from or en route to that location.

Embodiments of the present invention provide for a system and method for generating and providing actionable contextual insights to a user, based on a selected location, a selected timeframe, and the user's intent proposition. A user's intent proposition, for example, can be one or more directed goals that the invention's insights are intended to facilitate. For example a user may be a shopkeeper and the goal is to improve their operating margins. Or, for example, a user may be a traveling entity with an intent proposition to travel to a destination in the quickest, safest, or other goal, manner.

For purposes herein, a user can be a person, a store owner, a manager, an entity, a computer, a control system, an artificial intelligence-controlled interface, et al.

Embodiments of the present invention provide for generated insights which take into account the nature of the user's past, present, projected and/or intended future activities in, around, from or en route to that location using computing devices.

Embodiments of the present invention operate on a single computing device or operate as a connected system of computing devices where certain computing devices facilitate user interaction with the system, other computing devices provide sensors inputs to the system, other computing devices store required data, other computing devices either passively or actively gather data and other computing devices perform calculations on the existing and incoming data. For example, a user may interact with the system via a smart phone which also provides sensor inputs such as location and velocity while the other functions are provided by a set of computer servers distant from the user and communicating with the user's computing device over a data communications network.

Embodiments of the present invention provide for a location of interest as being provided as a street address.

Embodiments of the present invention provide for a location of interest by at least one location sensor that is part of the user's electronic device, e.g., portable computing device, smartphone, etc.

Embodiments of the present invention provide for a location of interest by a user interacting with a map-based user interface.

Embodiments of the present invention provide for multiple locations of interest that move and change over time as the user (actually or virtually) travels from one location to another. For example, the location(s) of interest include the user's current location, the user's next location on the route the user is following, and the user's destination location.

Embodiments of the present invention provide for a timeframe of interest as the current or actual time. Embodiments of the present invention provide for a timeframe of interest as a past time. Embodiments of the present invention provide for a timeframe of interest as a future time. Embodiments of the present invention provide for a timeframe of interest which changes either in lockstep with the actual time (e.g., one week from the current moment in time) or over a speculative future timespan (e.g., between 1 June and 7 June of a year in the future).

Embodiments of the present invention provide for insights that are provided to a user via push or pull technologies. For example, a notification of fire department activity that results in closing the street in front of a user's business can be sent to that user's cellular telephone via SMS text message to ensure timely receipt of the information.

Embodiments of the present invention provide for insights transmitted to a user via email. Embodiments of the present invention provide for insights provided to a user as part of a visual display of a single purpose software application. For example, a user's portable computing device has a software “app” that interacts with a service embodying the invention as software as a service (SaaS).

Embodiments of the present invention provide for insights provided as an overlay on a map of the geographic area encompassing the location(s) of interest. For example, increased neighborhood reports of rodents is shown as a heatmap overlaid on the user's neighborhood map display.

Embodiments of the present invention provide for insights provided to a user as words, displayed for reading or spoken in the user's preferred language (e.g., predetermined, default, or pre-set language). For example, a message such as “Fine risk—Conditions attracting rodents have been reported multiple times on your block” is provided to a user in spoken or written delivery.

Embodiments of the present invention provide for insights delivered to a user augmenting content on a third-party content site such as an online news story. For example, a user receiving or reading an online article about businesses closing in a specific neighborhood receives information about complaints about delays in infrastructure repairs, nearby stalled construction sites, and increased arrests in the area, for example, that can be displayed as an inset to the article itself. Or, for example, relevant or other articles related to the search or neighborhood or subject inquiry can be transmitted to a user.

Embodiments of the present invention provide for a user being a business owner or manager and the insights provided are specific to the location and context of their business.

Embodiments of the present invention provide for a user who is traveling from one location to another location and the insights provided are specific to the current location, the various destinations along the route being traveled and/or the user's destination.

Embodiments of the present invention provide for a user who is a consumer and the insights provided are specific to the location and context of the location the user is visiting or considering visiting.

Embodiments of the present invention provide for insights which include one or more suggested actions for a user to take. For example, a restaurant owner is notified that a shop on the block was fined because the shop was not vermin proof. Embodiments of the present invention provide for suggesting mitigating actions to reduce the user's own risk of fines. For example, a message can be provided to the user as follows: “seal all cracks, crevices, and holes in walls, cabinets and doors to prevent rodents from entering.”

Embodiments of the present invention provide for a user who makes available his/her own data about the past, present, or projections for the future such as customer receipts from a business, inventory reports or orders, number of reservations for a data, number of patrons currently at the location, etc. Such data is subsequently used to compute additional, hyper-targeted insights for the user.

Embodiments of the present invention provide for a user who is an outside observer or non-shop keeper, and the insights provided are specific to a range of locations of interest such as a neighborhood, block, or disjoint set of related business addresses.

### BRIEF DESCRIPTION OF THE DRAWINGS

FIG. 1 illustrates an example computing device for hosting the system according to an embodiment of the present invention.

FIG. 2 illustrates an example data set and interactions driving the insight generation according to an embodiment of the present invention.

FIG. 3 illustrates an example process for delivering user-specific insights in response to a user request according to an embodiment of the present invention.

FIG. 4 illustrates an example provides for delivering user-specific insights to a user in response to newly arriving event data according to an embodiment of the present invention.

FIG. 5 illustrates an example process for generating contextual insights for delivery to a user according to an embodiment of the present invention.

FIG. 6 illustrates an embodiment of the present invention.

FIG. 7 illustrates an embodiment of the present invention.

FIG. 8 illustrates an embodiment of the present invention.

FIG. 9 illustrates an example spatial subgraph and temporal subgraph according to an embodiment of the present invention.

FIG. 10 illustrates an example spatial subgraph, events subgraph, and temporal subgraph according to an embodiment of the present invention.

FIG. 11 illustrates an example spatial subgraph, events subgraph, and temporal subgraph according to an embodiment of the present invention.

FIG. 12 illustrates an example spatial subgraph, events subgraph, and temporal subgraph according to an embodiment of the present invention.

FIG. 13 illustrates an example spatial subgraph, events subgraph, and temporal subgraph according to an embodiment of the present invention.

FIG. 14 illustrates an example spatial subgraph and temporal subgraph according to an embodiment of the present invention.

FIG. 15 illustrates an example spatial subgraph, events subgraph, and temporal subgraph according to an embodiment of the present invention.

FIG. 16 illustrates an example spatial subgraph, events subgraph, and temporal subgraph according to an embodiment of the present invention.

FIG. 17 illustrates an example spatial subgraph, events subgraph, and temporal subgraph according to an embodiment of the present invention.

FIG. 18 illustrates an example system according to an embodiment of the present invention.

### DETAILED DESCRIPTION

Example embodiments of the present invention provide a method, device, system, and computer program product for ecommerce and social media. Example embodiments of the present invention provide for a generation of a contextual insight into a geographical area or subject area via an electronic device.

Several example embodiments are described herein, but are not meant to limit the scope of the invention. For example, the various embodiments described throughout are examples only and the similar system and method can be implemented for other situations in a variety of locations. In various examples herein, references are made to street geography; however, these references can also be to internal building or structures (e.g., a car, a chemical plant, any sort of housing, an electrical component, etc.), global views of locations, any spatial region that can be mapped, etc.

Further, the storage of data can be in standalone databases, relational databases, or ontology-based resources. For example, the storage of data can be in a Mongo database which is a document database, that is, everything is denormalized. From there, various tools are available to do a polygon inclusion. Embodiments of the present invention can be implemented via a variety of platforms.

Embodiments of the present invention provide systems for, e.g., customers, shops, travelers, entities, safety situations, schools, neighborhoods, greater communities, weather, etc.

In embodiments, data can be obtained from online sources, networked sources, manual input, API access to data, scraping of data from locations, etc.

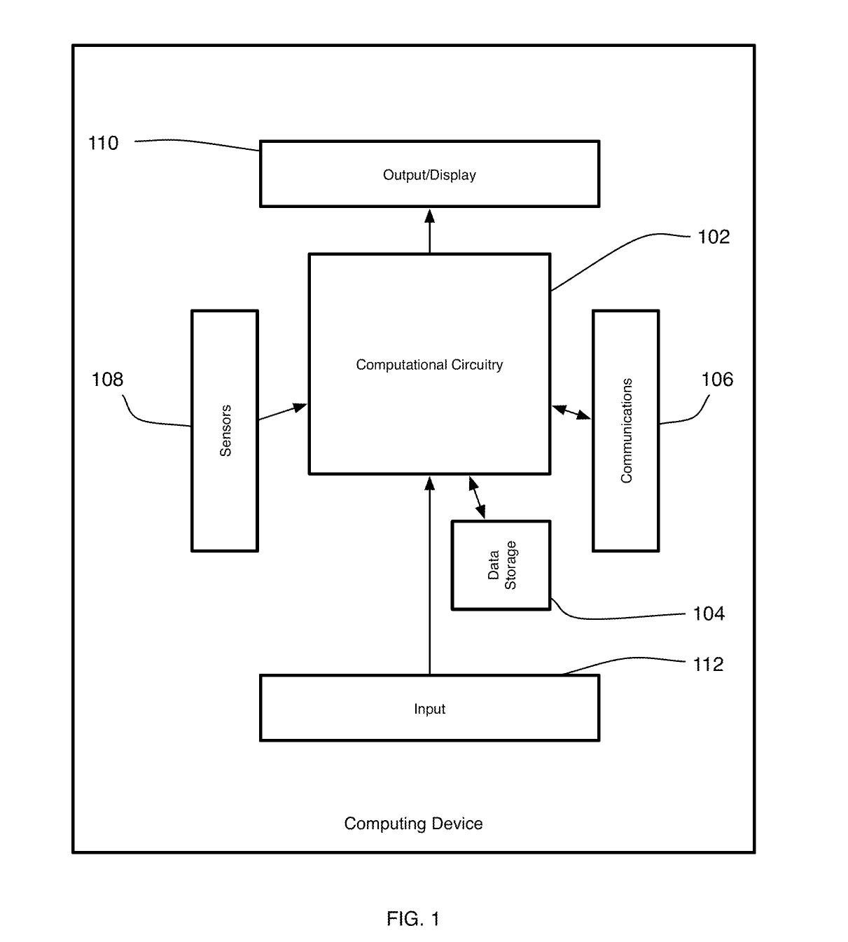

FIG. 1 illustrates an example computing device for hosting the system according to an embodiment of the present invention. Computing device 100 can include computational circuitry 102, including associated computer memory, data storage 104, communications 106, sensors 108, output/display 110 and input 112. For example, one or more of the components of computing device 100 can be combined or omitted. For example, computing device 100 includes other components not shown in FIG. 1. For example, multiple instances of computing device 100 may work together to provide the capabilities of the invention.

For example, computing device 100 includes any type of computing device. For example, computing device 100 includes a smart phone (e.g. an iPhone or Samsung Galaxy), a wearable computer (e.g., Google Glass), a tablet device (e.g. iPad, Google Nexus, Amazon Kindle Fire), a laptop computer, a desktop computer, a computer server (e.g. Dell PowerEdge) or virtual computer server (e.g., Amazon AWS EC2, Rackspace CloudServer or Microsoft Azure server).

For example, computing circuitry 102 includes any processing circuitry and memory to execute computer programs. For example, computing circuitry 102 is used to run operating systems (e.g. iOS, CentOS, etc.) and application programs written for the available hardware and operating system combination.

For example, data storage 104 includes one or more storage systems including, for example, solid state storage, disk storage, network attached storage and storage area networks using various technologies.

For example, communications 106 include one or more data communications capabilities including, for example, wired networks (e.g. Ethernet), wireless data networks (e.g. WiFi), Bluetooth, cellular broadband (e.g. 3G, 4G, LTE) and others.

For example, sensors 108 include one or more physical input sensors that provide data to the computing device. For example, sensors 108 include location sensors (e.g. GPS), motion sensors (e.g. accelerometers), direction sensors (e.g. compass), temperature sensors, cameras, near field communications sensors and/or others.

For example, Output/Display 110 includes one or more output/display devices that provide feedback to the user. For example, Output/Display 110 includes visual display capabilities (e.g. a computer screen) to present text, drawings, images or video in some embodiments of the invention. For example, Output/Display 110 includes sound output that supports spoken output or other sound-based alerting in some embodiments of the invention.

For example, Input 112 includes one or more input capabilities that provide means for input from the user. In embodiments of the invention input 112 can include text input via a virtual or actual keyboard, voice input via speech recognition, gesture based input via a touch screen or other sensor and/or motion based input via various accelerometers and motion sensors.

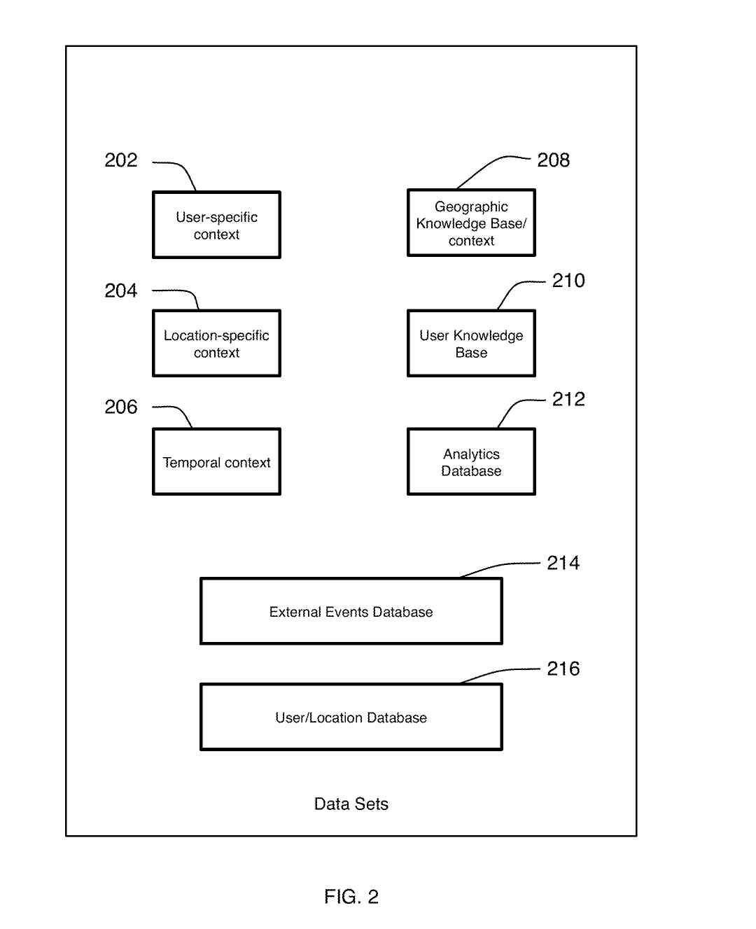

FIG. 2 illustrates an example data set and interactions driving the insight generation according to an embodiment of the present invention. For example, data sets 200 include user-specific context 202, location-specific context 204, temporal context 206, geographic knowledge base 208, user knowledge base 210, analytics database 212, external events database 214, and/or user location database 216. In embodiments of the invention, one or more of the components of data 200 can be combined or omitted. In embodiments, data sets 200 includes other components.

For example, User-specific context 202 is a set of data describing the user in a specific interaction with some embodiments of the invention. User-specific context 202 for a business owner user can include, for example, the business type, the business's hours of operation and historical information about the business (e.g. previous fines levied against the user, inspection reports about the user's business, daily receipts from the user's business over some time period, etc.). User-specific context 202 for a user traveling from one location to another can include, for example, the mode of travel (e.g. walking, biking, driving, taking mass transit), reason for travel (e.g. going to work, going home, going to purchase something) and user's travel history along the route {e.g. user has never travelled here, user often travels here) in accordance with embodiments of the invention.

For example, location-specific context 204 is a set of data describing the location in the context of a specific interaction with some embodiments of the invention.

For example, temporal context 206 is a set of data relating to the date and time in the context of a specific interaction with some embodiments of the invention.

For example, geographic knowledge base 208 is a set of data relating to the geographic and other location-based information utilized in embodiments of the invention. This can include, for example, topography, elevation, road networks, transit networks, transit stops and stations, transit schedules, building locations, building types (e.g. commercial, residential, mixed use), building footprints, building occupancy, real estate tax information, flood plain maps, census data, resident density, business density and/or real estate sales data.

For example, user knowledge base 210 is a set of data relating to types of users in some embodiments of the invention. This can include, for example, information about the reliance of a particular type of business on deliveries at specific times of the day, customer demographics (e.g. residents, workers, tourists, etc.), applicable regulations for different types of businesses, impact of different types of events on someone who is walking, versus biking, versus driving, versus using mass transit.

For example, analytics database 212 is a set of data created by various statistical and machine learning analyses of the historical data contained in one or more of 202, 204, 206, 208, 210, 214 and 216 in embodiments of the invention.

For example, external events database 214 is a set of data describing various gee-located events that have occurred, are occurring or are scheduled to occur that may impact one or more current or future users in embodiments of the invention.

For example, user/location database 216 is a set of data describing users, their characteristics, historical usage and associated locations in some embodiments of the invention. This can include, for example, when a user is a business owner, the name, address, type of business, street address and latitude/longitude of their business. As another example, when a ‘user’ is a news article in an online news publication, the content of 216 for that user can include the location relevant to the companion story as well as the sense of the insight requested (e.g. neighborhood ambience, crime trends, business climate, etc.). As yet another example, when a user is a traveler, the content of 216 for that user can include the initial location, current location, destination location, mode of transportation and reason for travel.

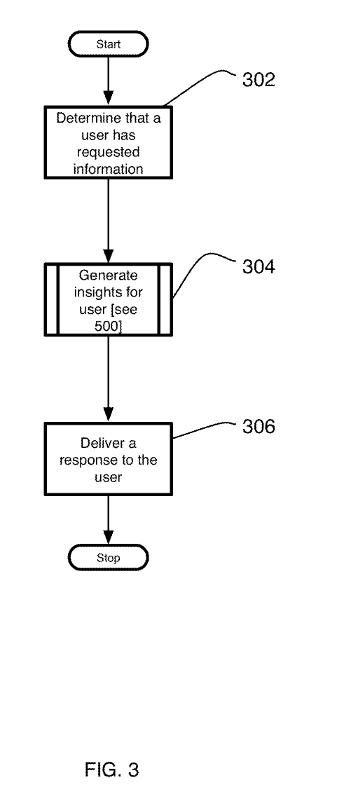

FIG. 3 illustrates an example process for delivering user-specific insights in response to a user request according to an embodiment of the present invention. FIG. 3 shows process 300 for delivering contextual insight for a user at a particular moment in time in response to that user's request. At step 302, process 300 can determine that the user has requested the system provide new or updated contextual insights. For example, process 300 receives an explicit application program interface (API) request in response to the user signing on to the application. As another example, process 300 receives a request based on the user's computing device 100 detecting that the user has moved to a new location. At step 302, process 300 has access to the target location and in some embodiments of the invention, also has access to the user's identifying credentials.

At step 304, process 300 generates contextual insights for the user as described in process 500.

At step 306, process 300 delivers the contextual insights generated by process 500 for presentation to the user via one or more output devices 110 on the user's computing device 100.

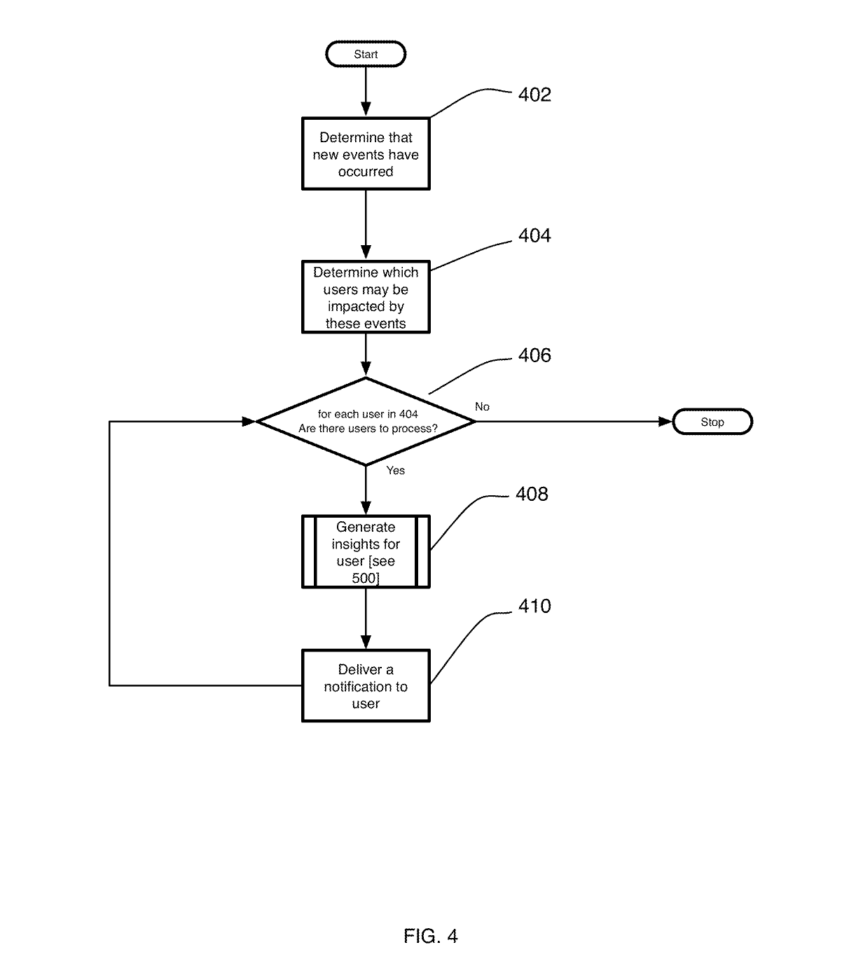

FIG. 4 illustrates an example provides for delivering user-specific insights to a user in response to newly arriving event data according to an embodiment of the present invention. FIG. 4 shows process 400 for generating contextual insight for a user at a particular moment in time in response to receipt of impactful event data. At step 402, process 400 can determine that new events have been added to the external events database 214.

At step 404, process 400 selects all users from 216 that may be impacted by the new events that were added to 214. This selection is driven by the user's selected location (e.g. the user's actual location, the user's business location, the user's destination location, or some other location selected by the user as appropriate for some embodiments of the invention), the user's intent proposition, the type of event that occurred, the location impact extent of the event (e.g. a large scale event, such as an emergency road closure somewhat distant from a user's selected location may have more impact than a localized event such as sidewalk repair close to the user's selected location), the temporal impact extent of the event and data from one or more of 202, 204, 206, 208, 210, 212 and 216.

At decision point 406, process 400 loops through each user selected at step 404. For each user at step 408, process 400 generates contextual insights for the user as described in process 500.

At step 410, process 400 delivers the contextual insights generated by process 500 for presentation to the user via one or more output devices 110 on the user's computing device 100.

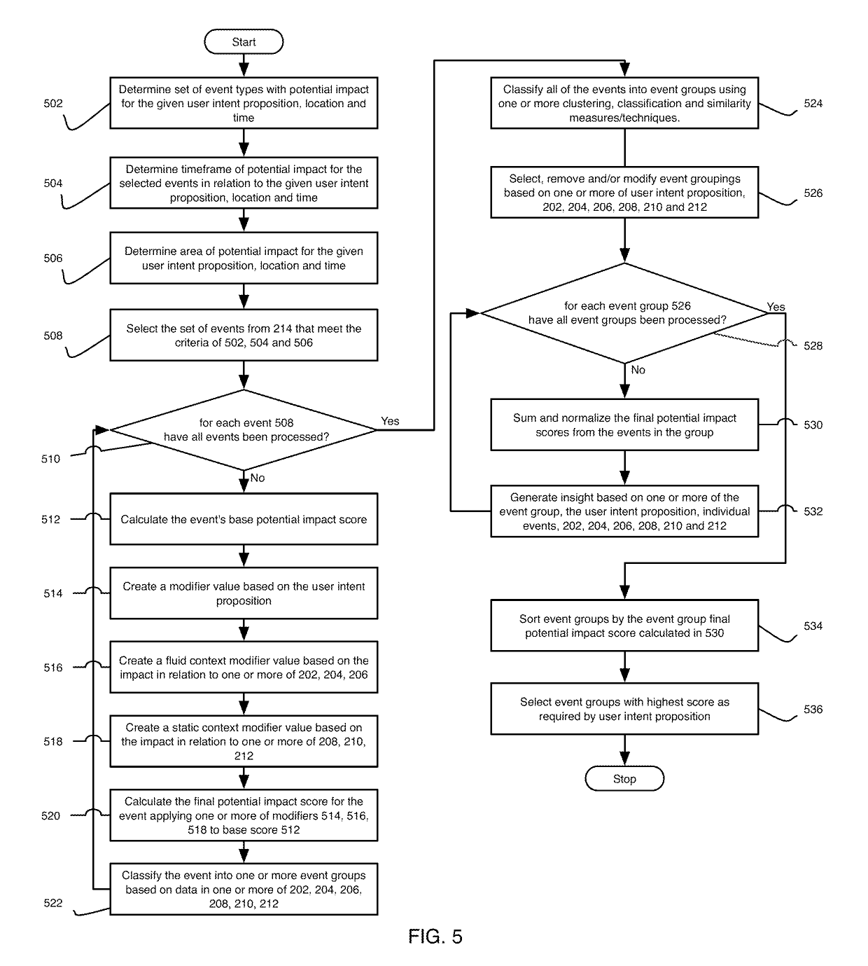

FIG. 5 illustrates an example process for generating contextual insights for delivery to a user according to an embodiment of the present invention. FIG. 5 shows process 500 for generating contextual insights for delivery to a user based on one or more of that user's intent propositions. Process 500 is invoked for a specific user. The user has a selected location (e.g. the user's actual location, the user's business location, the user's destination location, etc.) or multiple related locations as appropriate for some embodiments of the invention. For example, the user also has one or more intent propositions or goals. Process 500 has available the user's location, the user's intent proposition and the user's selected timeframe. At step 502, process 500 determines the set of event types that could potentially impact the user given the selected location, timeframe and intent proposition. At step 504, process 500 determines the timeframe of potential impact for each of the event types determined at step 502. At step 506, process 500 determines the area of potential impact for each of the event types determined at step 502. At step 508, all events from data set 214 that meet the criteria determined in steps 502, 504 and 506 are retrieved.

Decision point 510 represents the concept of an iterator over each event retrieved in step 508. In embodiments, process 500 executes steps 512, 514, 516, 518, 520 and 522 for each event. In embodiments, one or more of steps 514, 516, 518 are combined, modified, or omitted. In some embodiments additional scoring modification steps are added.

In step 512 the event's base potential impact score is assigned. In embodiments, the base potential impact score is assigned from a subject matter expert assessment. In embodiments, the base potential impact score is calculated from historical data that may include actual historical impact analysis from this or comparable users. In some embodiments of the invention, the base potential impact score may be crowd-sourced.

In step 514 a modifier value is determined based on the user intent proposition. In embodiments, the user intent proposition modifier is assigned from a subject matter expert assessment. In embodiments, the user intent proposition modifier is calculated from historical data that can include actual historical impact analysis from this or comparable users. In embodiments, the user intent proposition modifier are crowd-sourced. In other embodiments, the user intent proposition modifier is calculated using fuzzy logic based approaches, rule-based techniques (e.g. RETE) or a combination of the two or other available methods.

In step 516, a fluid context modifier value or set of values is determined based on data in 202, 204 and/or 206. In embodiments, the fluid context modifiers are assigned from a subject matter expert assessment. In embodiments, the fluid context modifiers are calculated from historical data that can include actual historical impact analysis from this and/or comparable users. In embodiments, the fluid context modifiers can be crowd-sourced. In other embodiments, the fluid context modifier can be calculated using fuzzy logic based approaches, rule-based techniques (e.g. RETE) or a combination of the two or other available methods.

In step 518, a static context modifier value is determined based on data in 208, 210 and/or 212. In some embodiments of the invention, the static context modifier is assigned from a subject matter expert assessment. In some embodiments of the invention, the static context modifier is calculated from historical data that may include actual historical impact analysis from this or comparable users. In some embodiments of the invention, the static context modifier may be crowd-sourced. In still other embodiments of the invention, the static context modifier may be calculated using fuzzy logic based approaches, rule-based techniques (e.g. RETE) or a combination of the two.

In some embodiments of the invention one or more of steps 514, 516 and 518 may be modified or omitted. In some embodiments of the invention additional mathematical modifiers may be added and subsequently applied in step 520.

In step 520, process 500 calculates a final potential impact score for the event. In embodiments, the base potential impact score of step 512 may be modified by one or more of the modifiers described above. In embodiments, the modifiers can be added to the base potential impact score to calculate the final potential impact score. For example:

final_score=base_score+modifier1+modifier2

In embodiments, the modifiers and the base potential impact score are multiplied together to calculate the final potential impact score. For example:

final_score=base_score·modifier1·modifier2·modifier3

In other embodiments, the modifiers and the base potential impact score can be terms of a more advanced formula, for example:

final score=base_scoreA2+2*modifier1+0.5·modifier2−modifier3

In step 522, process 500 classifies the event into one or more abstract event categories. In embodiments, an event category is assigned by a subject matter expert assessment. In embodiments, an event category is determined from historical data that include actual historical associations from this or comparable user intent propositions. In embodiments, the event category assignment is crowd-sourced. In embodiments, the event category can be determined using fuzzy logic based approaches, rule-based techniques (e.g. RETE) or a combination of the two or other available methods.

In an embodiment, when all events have been processed, each event has a final potential impact score and each event has been assigned to one or more event groups. Decision point 510 now directs process 500 to step 524.

In step 524 one or more clustering, classification or other machine learning techniques are applied to the set of events selected in step 508 resulting in each event being assigned to one or more event groups. In some embodiments of the invention both step 522 and step 524 occur, resulting in two sets of event groups. In some embodiments of the invention only one of step 522 or 524 occur. In embodiments of the invention, additional machine learning techniques not explicitly detailed here are applied to generate the event groupings.

At step 526, the event groupings are analyzed and one or more of the groupings can be removed or modified. During this analysis individual event potential impact scores can also be modified. In embodiments, analysis may take into account clustering or categorization quality metrics (e.g. for example, f-measure). In embodiments, heuristics can be used to select, remove or modify the event groupings. In embodiments, the entire set of event groupings may be used without modification. In embodiments, the event groupings may be selected, removed or modified using fuzzy logic based approaches, rule-based techniques (e.g. RETE) or a combination of the two or other available methods.

In embodiments, decision point 528 represents the concept of an iterator over each event group from step 526. In this iterator, process 500 executes step 630 and step 632 for each event group. When all event groups have been processed, decision point 528 transfers execution to step 534.

At step 530, process 500 sums the final potential impact scores from each event in the event group and assigns that score as the potential impact score for the event group. In some embodiments of the invention, the potential impact scores from one or more of the events in the group are scaled, normalized, averaged or otherwise modified.

At step 532, an insight is generated based on one or more of the event group, user intent proposition, individual events, and data from 202, 204, 206, 208, 210 and 212. In embodiments, the insight is in the form of a probability, for example: “There is an 87% probability that your shop will be inspected for vermin by the Department of Health in the next 48 hours.” In embodiments, the insight is in the form of a suggestion, for example: “En route to your destination, avoid Broadway between 20 Street and 15 Street due to a water main break.” In embodiments, the insight is assigned by a subject matter expert assessment. In embodiments, the insight is determined from historical data that can include actual historical associations from this or comparable user intent propositions. In embodiments, the insight is crowd-sourced. In embodiments, the insight is determined using fuzzy logic based approaches, rule-based techniques (e.g. RETE) or a combination of the two or other available methods.

When decision point 528 determines that all event groups have been processed, execution proceeds with step 534. At step 534 the event groups are sorted from highest potential impact score to lowest potential impact score.

At step 536 one or more event groups are selected from the sorted list of 534 based on the number required by the user intent proposition. In embodiments, only the top ranked event group will be returned. In embodiments, all the event group will be returned. In embodiments, a specific number of event groups will be returned. In embodiments, only the event groups possessing a score above a threshold value will be returned. In embodiments, the event group and its associated events, insights and scores will be returned. In embodiments, only certain components of the event group will be returned, for example, only the insight associated with that group.

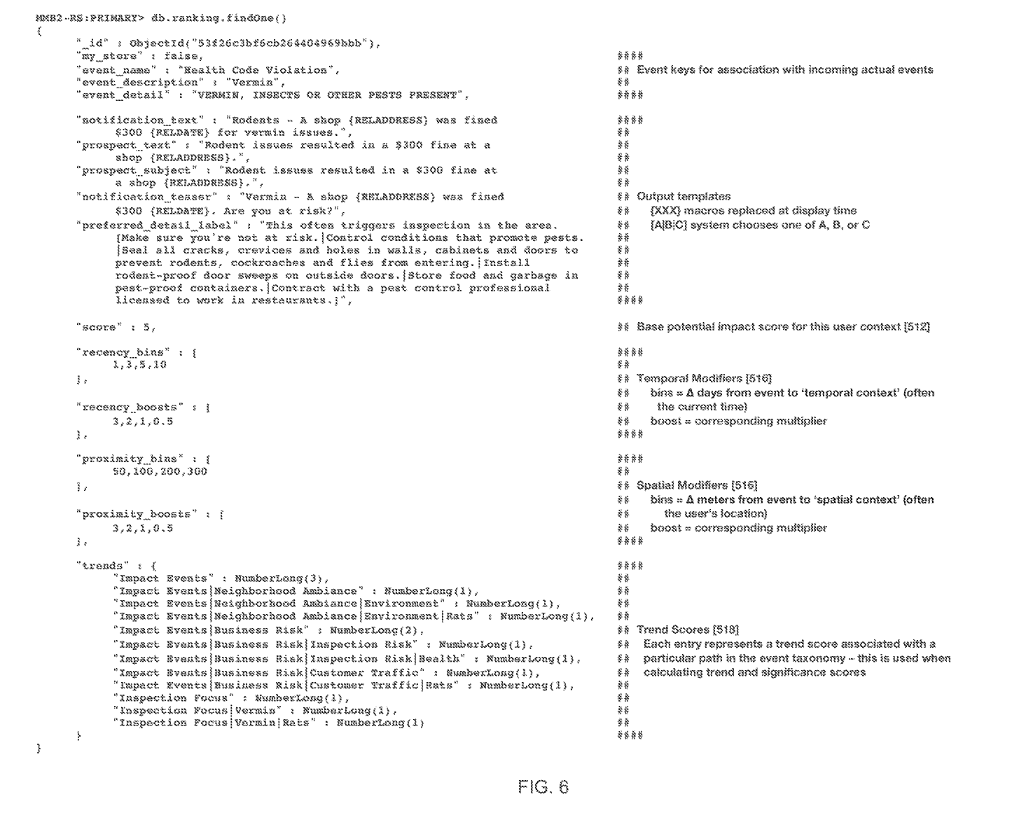

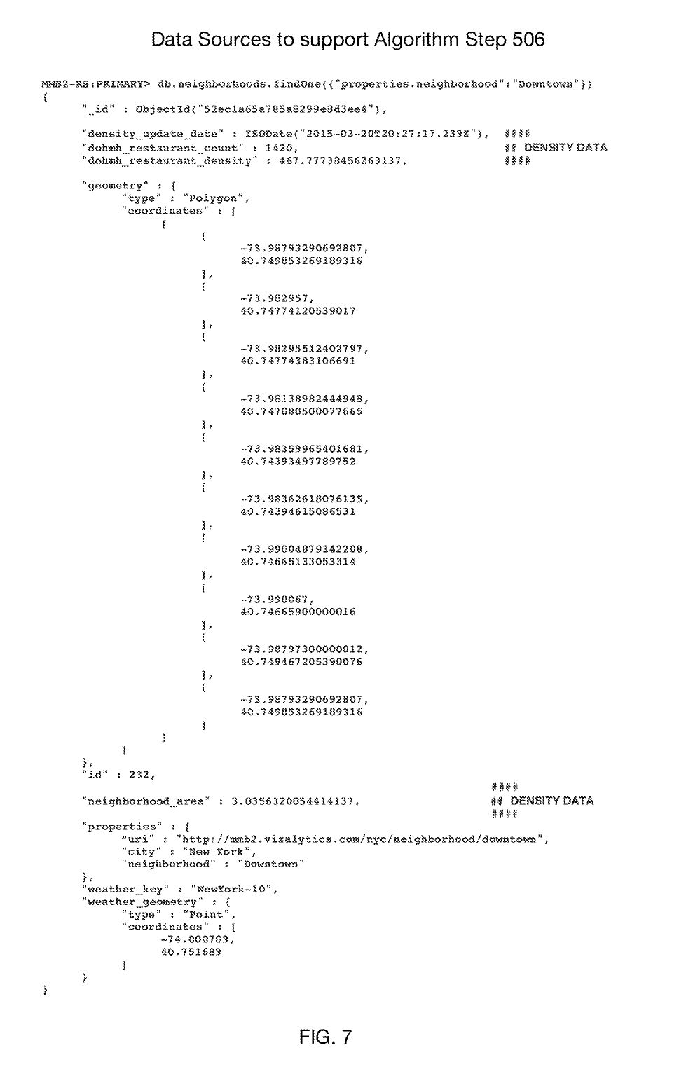

FIG. 6 shows data sources and the like to support steps 510 through 536 of FIG. 5. FIG. 7 shows data sources and the like to support step 506 of FIG. 5. In order to determine the polygon or geo-region or area, it can be SME based, static database having specific assumptions based on previous data or statistical probabilities regarding time, distance, and impact for a specific class of event. Or, for example, this can be done with machine learning approaches and other methods as described. FIGS. 6 and 7 show an example of the distance and time data for each event class that has been built up manually or otherwise provided. In an embodiment, another way of determining impact, impact distance and time is through analysis of user actions by users we have on the product, for example: How long do they pay attention to a rat report. How far away are people they share it with. If it's close do they interact with the alert more than if it's far away. One can see how with many users that the system can effectively refine these parameters and factors through machine learning or other techniques automatically. The system and method of the present invention updates and improves itself as it acquires more data.

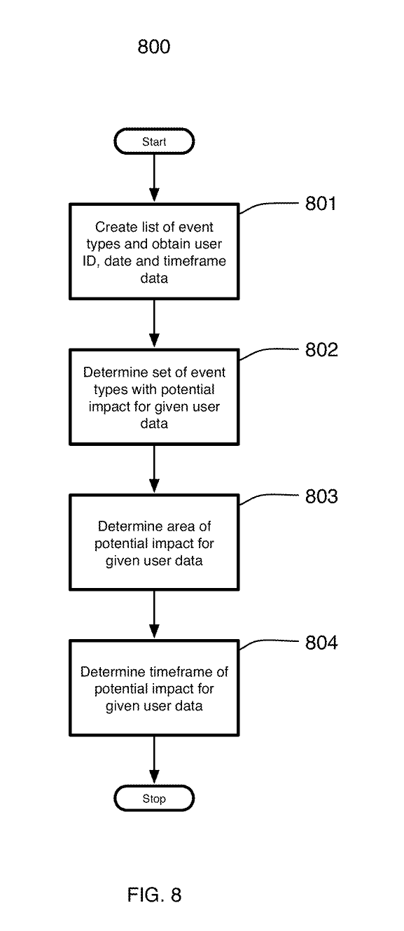

FIG. 8 illustrates an embodiment of the present invention. FIG. 800 illustrates an example functionality of the system according to an embodiment of the invention. At step 801, method 800 creates a list of event types. Method 800 can also accept user input, such as a user name, a date period and a time period. At step 802, method 800 determines the set of event types with potential impact for the given user intent proposition, location and time. At step 803, method 800 calculates the area of potential impact for the given user intent proposition, location and time. Method 800 sorts neighborhood information based on user name. For example, method 800 determines all valid neighborhood values, and obtain the restaurant density in each of those neighborhoods. For example, method 800 determines whether the restaurant density for each neighborhood is above or below the density thresholds. Upon determining that the density is within the density threshold range, method 800 calculates the area of potential impact. Upon determining that the density is not with the density threshold range, method 800 assigns a preset value to the area of potential impact.

At step 804, method 800 determines the timeframe of potential impact for the selected events in relation to the given user intent proposition, location and time. For example, method 800 takes into account the area of the potential impact as calculated during step 803, the selected event types, the geometry of the area of impact and the time frames as input by the user among other factors. For example, method 800 organizes these factors into an array and checks the array against certain conditions. Method 800 builds a query object including the above mentioned factors that can be passed to a repository containing query operations to narrow the relevant time frame. After narrowing the time frame appropriately, method 800 determines the time frame of potential impact.

In an embodiment, the call pulls from the database. The record returned has the, e.g., neighborhood geometry or polygon or region of interest and some metadata. Among the metadata is, for example, a calculation of the, e.g., neighborhood business density. This is calculated using a number of restaurants as a proxy for a number of overall businesses and the area (e.g., in square meters) of the neighborhood or polygon geometry. In an example, this can be calculated as a ratio in order to achieve the density.

In FIG. 8, an example online resource to obtain information for the process is from the New York City Department of Health and Mental Hygiene (DOHMH) which is the agency that inspects restaurants. There are other resources, and other methods for obtaining data. For example, data can be held in one or more static databases, data can be updated dynamically, data can be pulled from social media sites including, e.g., Facebook, Instagram, etc., and other resources. Data can also be inputted directly by one or more users either through an interface of the app or manually through the backend or other available method.

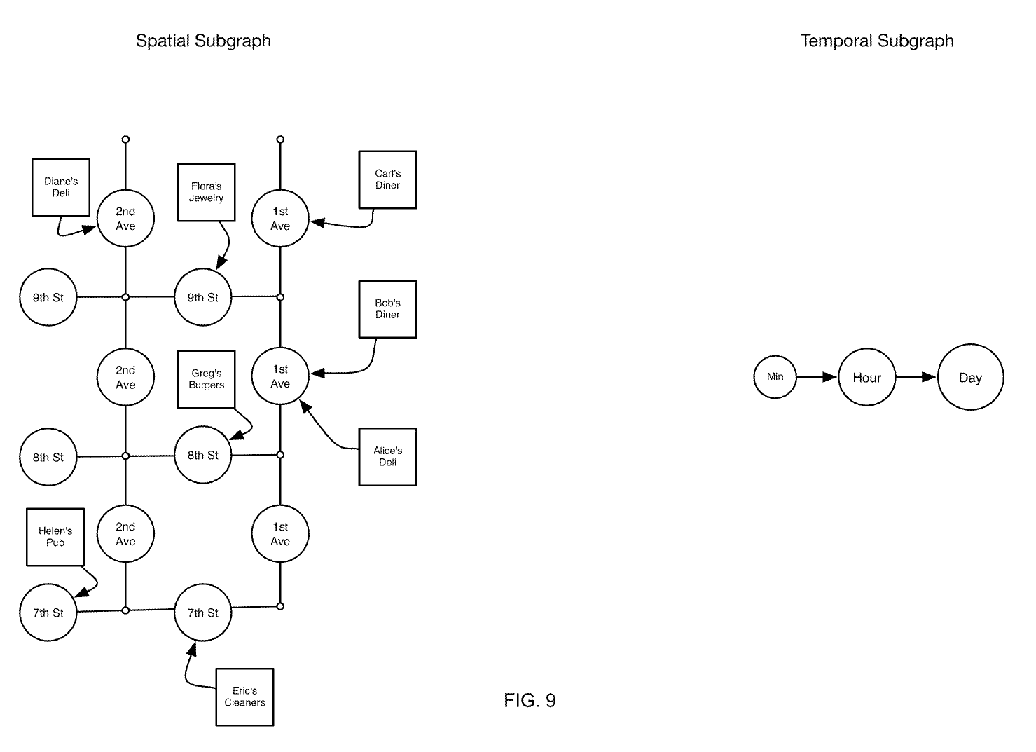

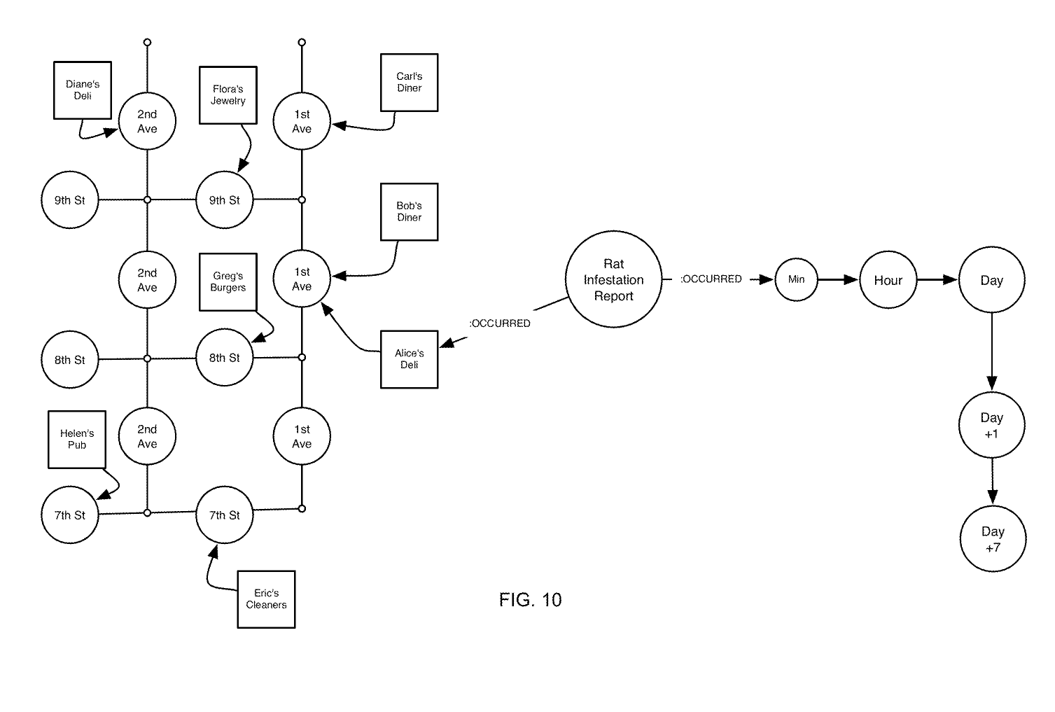

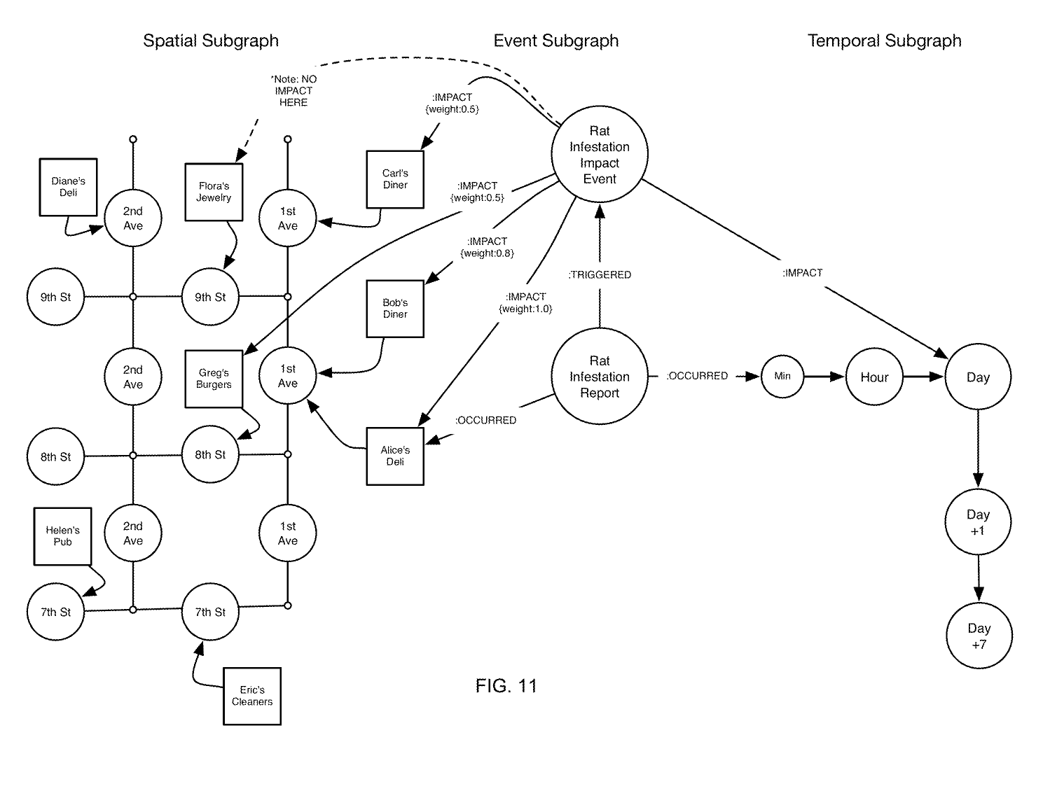

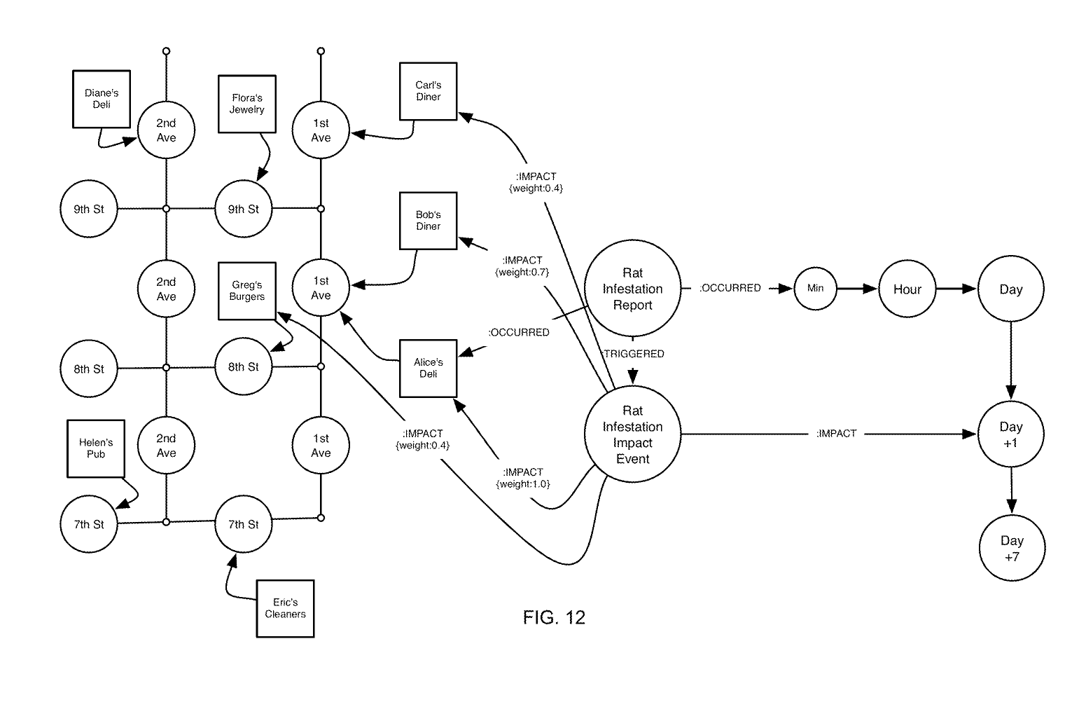

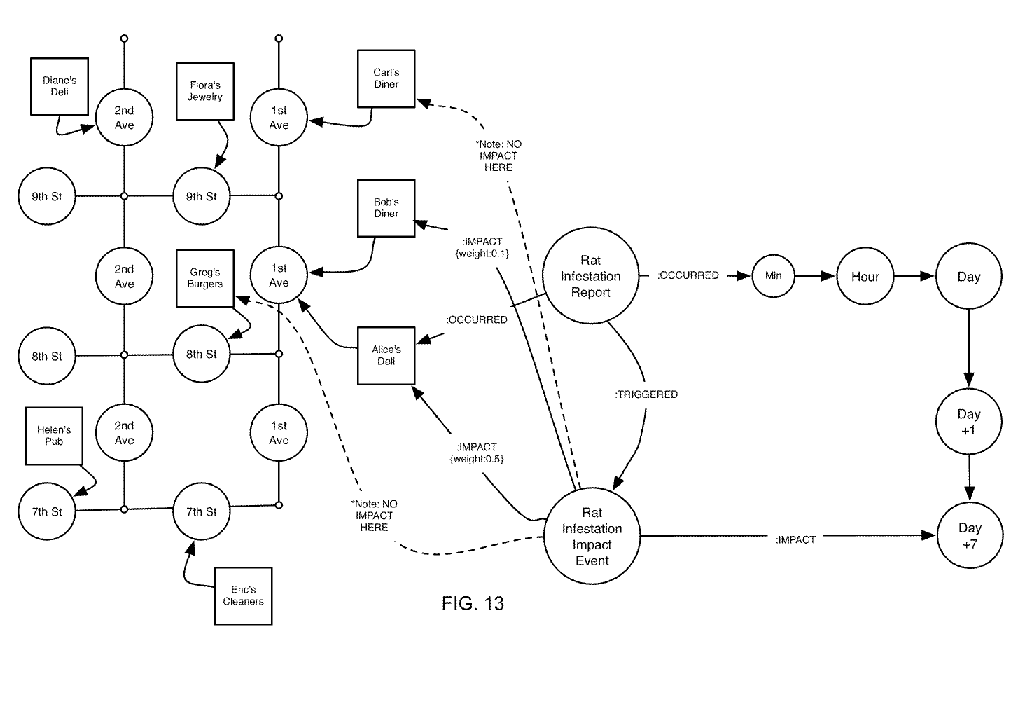

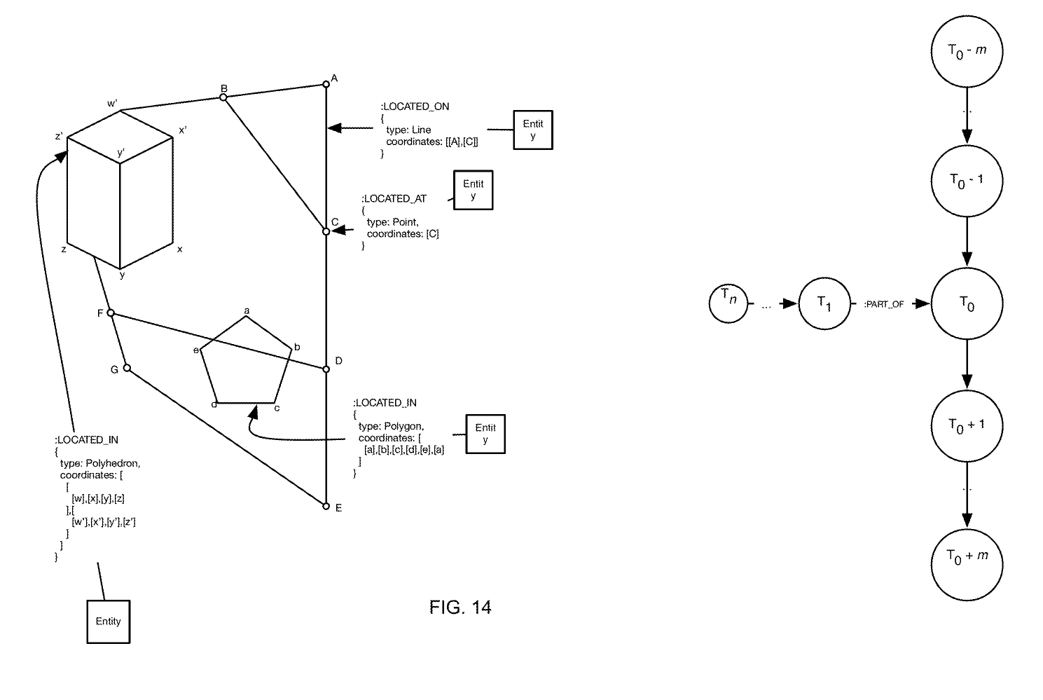

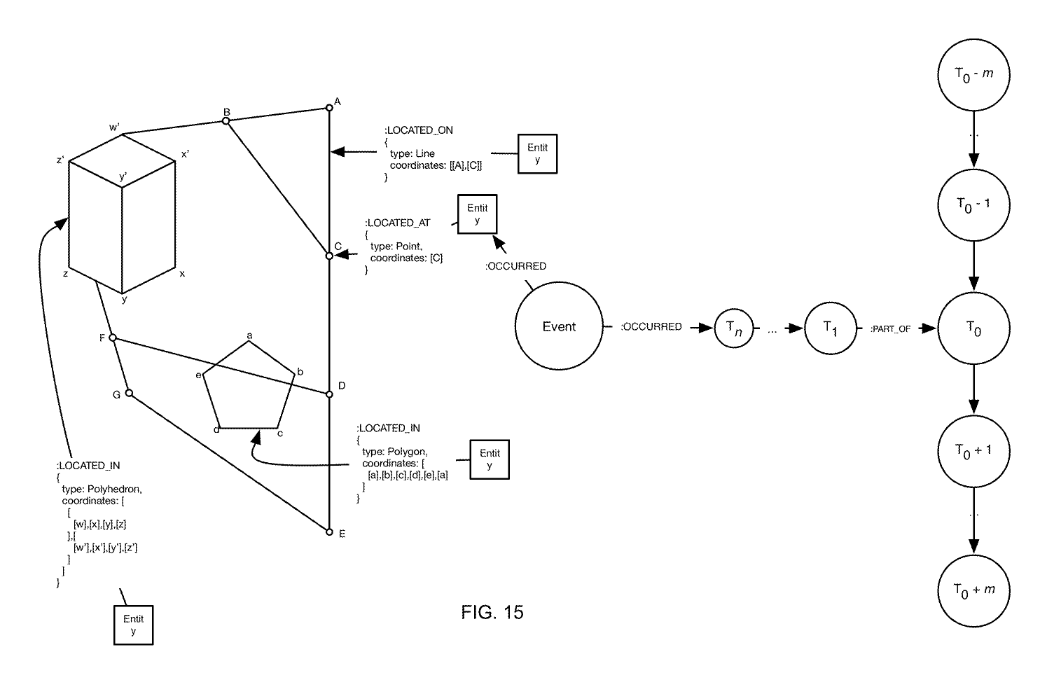

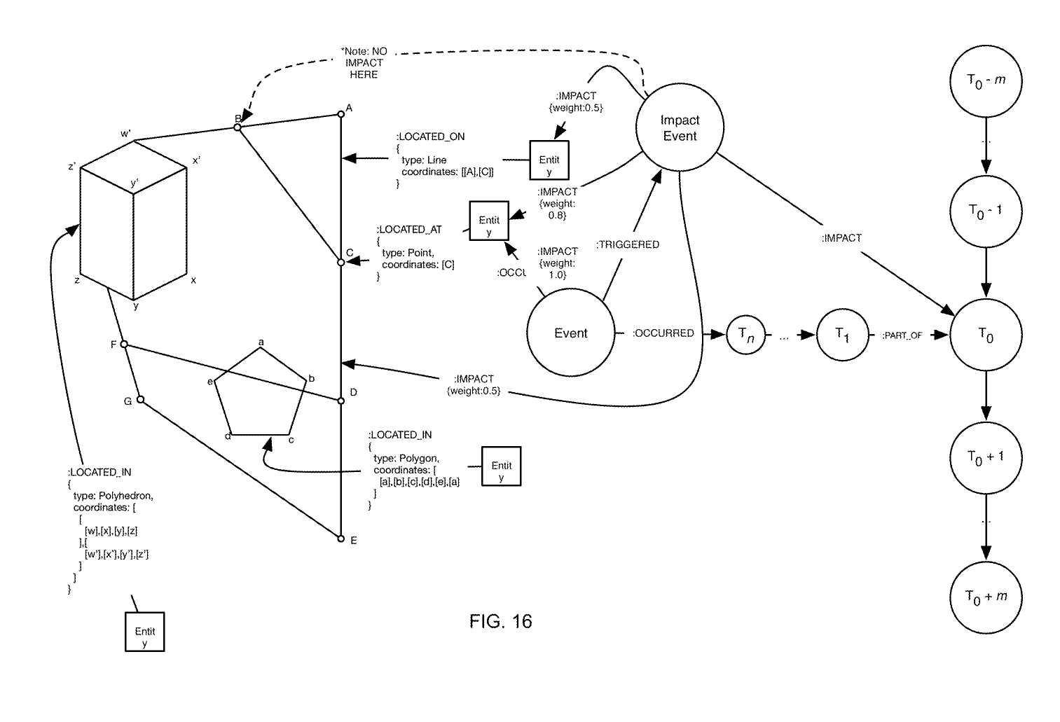

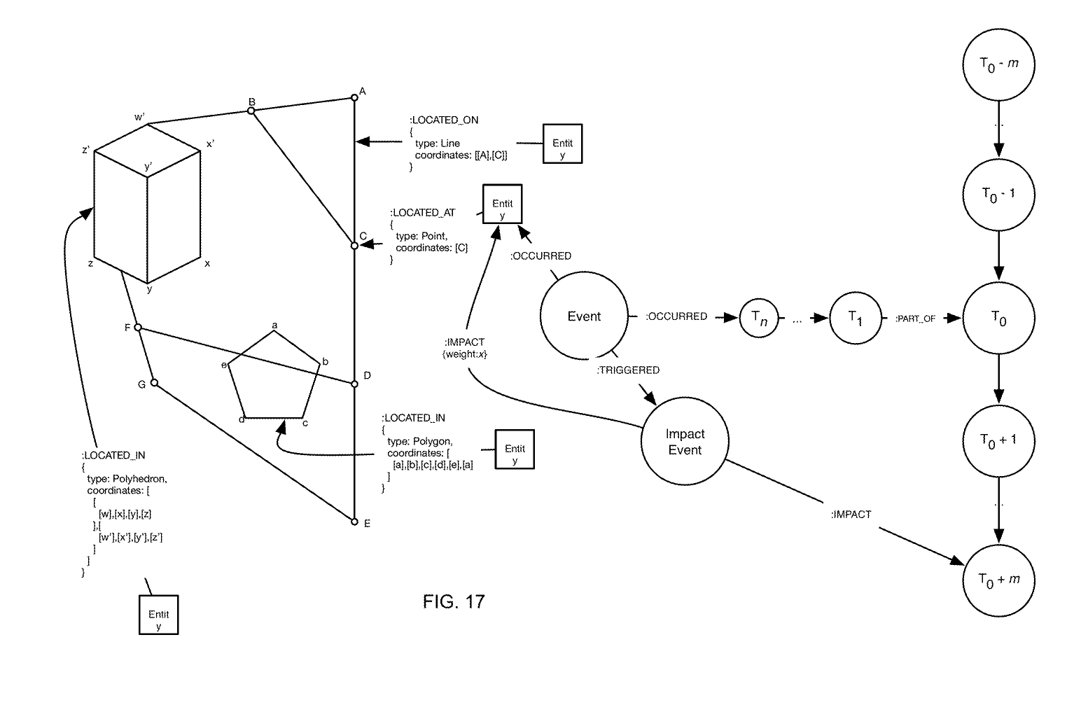

FIGS. 9 through 17 illustrate various example spatial, event, and temporal subgraphs according to an embodiment of the present invention. For example, FIG. 9 shows a spatial subgraph of a neighborhood associated with a temporal subgraph from minutes to days. For example, if a user's interest is in Flora's Jewelry on 9^{th} street at timeframe X, then the system looks at all the relevant data to Flora's Jewelry. Here, the spatial information involves the geography around the area of interest, including such details as the building specifics such as percentage commercial, percentage residential, taxes paid, when the structure was built, size of building, number of floors. Spatial subgraph also tracks the distance between different locations on the graph. In FIG. 10, for example, an event subgraph is also shown. The event subgraph shows a rat infestation report. The details would include when the event occurred, at which time and place. Embodiments of the present invention align the ontologies in based on the intent proposition. For example, a restaurant owner such as Greg's Burgers might be interested in a rat infestation report occurring within a certain distance. Accordingly, embodiments of the present invention determine the relevant weighting (e.g., a rat infestation report is more relevant to a restaurant shop than a jewelry shop). Or, for example, an event can be a street closure at time x at location y. The location and time information happen along vectors and can be used accordingly. For example, impact events are associated with specific locations and time frames, having different weightings of importance and lasts in various levels of importance over a specific length of time. The temporal subgraph runs along the spatial and event subgraphs. For example, for a rat infestation event, after day x, all companies might have the same weighting on the report. After day y, a company having a woodframe built in the early 1900s might have a heavier weighting of the event report (rat infestation) than a company in a new building made of glass, or one that is a further distance from the location that had the rat infestation report (or other impact event).

For example, if a user is interested in a location at 5^{th} ave and 36^{th} street. An embodiment of the present invention generates a subgraph of specific polygon shape including that location. Based on the user and type of inquiry (e.g., foot traffic expected, weather, whether a location might get inspected, etc.), then the system determines what to display or provide information on to the user. In an embodiment, a linear regression is employed in order to determine trends.

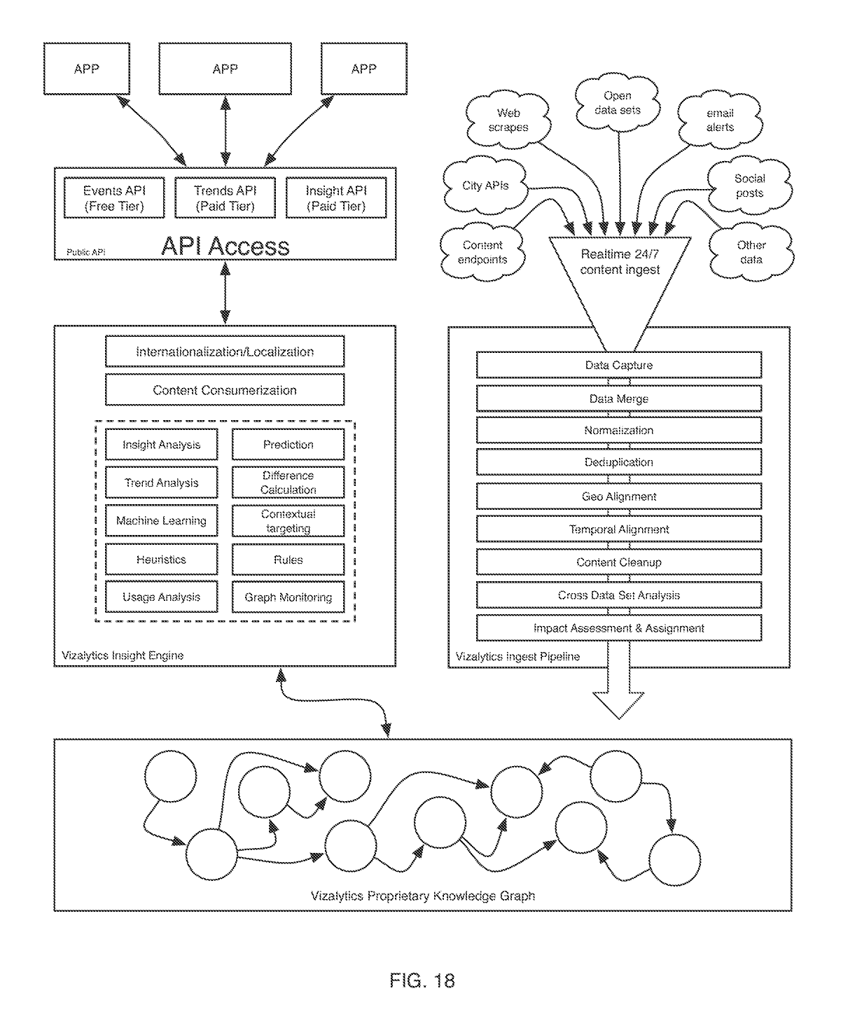

FIG. 18 illustrates an example system according to an embodiment of the present invention. In FIG. 18, a user accesses an app. The app accesses an API layer which provides access to an insight engine. The insight engine includes a variety of modules including prediction, rules, usage, heuristics, machine learning, graph monitoring, calculation, trend, and insight modules, among others. The system accesses and provides a graph (if desired). Also contributing to the resulting graph is the data obtained from a variety of resources by the ingest pipeline, which can obtain data in realtime, from static databases, et al. For example, data is obtained from content endpoints, city APIs, web scrapes, open data sets, email alerts, social media posts, data feeds, weather databases, etc. The data is captured from one or more of the resources, merged into a usable file(s), normalized, deduplicated (redundancies removed), geo-aligned, temporally aligned, content cleaned, cross data analyzed, and impact assessment and assignment is performed.

A method for providing insights, including receiving by a processor an inquiry by a user regarding at least one of a geographical location, a timedate, and an impact event; processing the inquiry by a processor, in view of an insight analysis, to determine at least one a region of the geographical location, the geographical location at the timedate and a series of times surrounding that timedate, and a location associated with the impact event; analyzing the inquiry in view of the determinations and obtaining at least one of event data, time data, and spatial data by a processor from at least one resource associated with the analysis of the inquiry; and generating an output including at least one insight from the insight analysis associated with the at least one of the geographical location, the time date, and the impact event according to the inquiry along with the at least one of event data, time data, and spatial data associated with the analysis of the inquiry. The method wherein the at least one resource is an online database, a website, a social media site, a manual input, a data feed, a city information resource, and a static database. The method wherein the impact event is at least one of an agency report, an emergency situation, a closed area, damage to a structure, an accident, a celebration event, a road or location closure, and a parade or other event. The method providing additional information regarding the at least one of the geographical location, the timedate, and the impact event from at least one of: an online news source, a weather source, and a social media source. The method wherein the at least one insight is a constructive notice regarding a fine, a warning, and a mitigating opportunity in view of the impact event.

A system, including a processor for receiving a transmitted user input inquiry regarding at least one of a geographical location, a timedate, and an impact event; a processing module to determine at least one a region of the geographical location, the geographical location at the timedate and a series of times surrounding that timedate, and a location associated with the impact event; an analysis module to analyze the inquiry in view of the determinations and output a request for additional data, wherein the processor obtains the additional data in the form of at least one of event data, time data, and spatial data from at least one resource; and an output module for generating an output including at least one insight associated with the at least one of the geographical location, the time date, and the impact event according to the inquiry along with the at least one of event data, time data, and spatial data associated with the analysis of the inquiry. The system wherein the at least one resource is an online database, a website, a social media site, a manual input, a data feed, a city information resource, and a static database. The system wherein the impact event is at least one of an agency report, an emergency situation, a closed area, damage to a structure, an accident, a celebration event, a road or location closure, and a parade or other event. The system wherein additional information is obtained by the processor regarding the at least one of the geographical location, the timedate, and the impact event from at least one of: an online news source, a weather source, and a social media source. The system wherein the at least one insight is a constructive notice regarding a fine, a warning, and a mitigating opportunity in view of the impact event. A non-transitory computer readable medium having instructions thereon which can be executed to perform the following method including receiving by a processor an inquiry by a user regarding at least one of a geographical location, a timedate, and an impact event; processing the inquiry by a processor, to determine at least one a region of the geographical location, the geographical location at the timedate and a series of times surrounding that timedate, and a location associated with the impact event; analyzing the inquiry in view of the determinations and obtaining at least one of event data, time data, and spatial data by a processor from at least one resource associated with the analysis of the inquiry; and generating an output including at least one insight associate with the at least one of the geographical location, the time date, and the impact event according to the inquiry along with the at least one of event data, time data, and spatial data associated with the analysis of the inquiry. The medium, wherein the at least one resource is an online database, a website, a social media site, a manual input, a data feed, a city information resource, and a static database. The medium, wherein the impact event is at least one of an agency report, an emergency situation, a closed area, damage to a structure, an accident, a celebration event, a road or location closure, and a parade or other event. The medium further providing additional information regarding the at least one of the geographical location, the timedate, and the impact event from at least one of: an online news source, a weather source, and a social media source. The medium wherein the at least one insight is a constructive notice regarding a fine, a warning, and a mitigating opportunity in view of the impact event.

It should be appreciated that the present invention can be implemented in numerous ways, including as a process, an apparatus, a system, a computer processor executing software instructions, or a computer readable medium such as a non-transitory computer readable storage medium, or a computer network wherein program instructions are sent over optical or electronic communication or non-transitory links. It should be noted that the order of the steps of disclosed processes can be altered within the scope of the invention, as noted in the appended claims and in the description herein.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

The computer processor and algorithm for conducting aspects of the methods of the present invention may be housed in devices that include desktop computers, scientific instruments, hand-held devices, personal digital assistants, phones, a non-transitory computer readable medium, and the like. The methods need not be carried out on a single processor. For example, one or more steps may be conducted on a first processor, while other steps are conducted on a second processor. The processors may be located in the same physical space or may be located distantly. In some such embodiments, multiple processors are linked over an electronic communications network, such as the Internet. Preferred embodiments include processors associated with a display device for showing the results of the methods to a user or users, outputting results as a video image and the processors may be directly or indirectly associated with information databases. As used herein, the terms processor, central processing unit, and CPU are used interchangeably and refer to a device that is able to read a program from a computer memory, e.g. ROM or other computer memory, and perform a set of steps according to the program. The terms computer memory and computer memory device refer to any storage media readable by a computer processor. Examples of computer memory include, but are not limited to, RAM, ROM, computer chips, digital video discs, compact discs, hard disk drives and magnetic tape. Also, computer readable medium refers to any device or system for storing and providing information, e.g., data and instructions, to a computer processor, DVDs, CDs, hard disk drives, magnetic tape and servers for streaming media over networks.

Embodiments of the present invention provide for accessing data obtained via a user's smartphone, smart device, tablet, iPad®, iWatch®, or other device and transmit that information via a telecommunications, WiFi, or other network option to a location, or other device, processor, or computer which can capture or receive information and transmit that information to a location. In an embodiment, the device is a portable device with connectivity to a network or a device or a processor. Embodiments of the present invention provide for a computer software application (or “app”) or other method or device which operates on a device such as a portable device having connectivity to a communications system to interface with a user to obtain specific data, push or allow for a pull, of that specific data by a device such as a processor, server, or storage location. In embodiments, the server runs a computer software program to determine which data to use, and then transforms and/or interprets that data in a meaningful way.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. The various features of embodiments described can be used with and without each other, in various combinations. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A method, comprising:
receiving by a processor an inquiry by a user regarding at least one of a geographical location, a timedate, and an impact event;
processing the inquiry by a processor, in view of an insight analysis, to determine at least one a region of the geographical location, the geographical location at the timedate and a series of times surrounding that timedate, and a location associated with the impact event;
analyzing the inquiry in view of the determinations and obtaining at least one of event data, time data, and spatial data by a processor from at least one resource associated with the analysis of the inquiry; and
generating an output including at least one insight from the insight analysis associated with the at least one of the geographical location, the time date, and the impact event according to the inquiry along with the at least one of event data, time data, and spatial data associated with the analysis of the inquiry.

2. The method of claim 1, wherein the at least one resource is an online database, a website, a social media site, a manual input, a data feed, a city information resource, and a static database

3. The method of claim 1, wherein the impact event is at least one of an agency report, an emergency situation, a closed area, damage to a structure, an accident, a celebration event, a road or location closure, and a parade or other event.

4. The method of claim 1, further comprising: providing additional information regarding the at least one of the geographical location, the timedate, and the impact event from at least one of: an online news source, a weather source, and a social media source.

5. The method of claim 1, wherein the at least one insight is a constructive notice regarding a fine, a warning, and a mitigating opportunity in view of the impact event.

6. A system, comprising:
a processor for receiving a transmitted user input inquiry regarding at least one of a geographical location, a timedate, and an impact event;
a processing module to determine at least one a region of the geographical location, the geographical location at the timedate and a series of times surrounding that timedate, and a location associated with the impact event;
an analysis module to analyze the inquiry in view of the determinations and output a request for additional data, wherein the processor obtains the additional data in the form of at least one of event data, time data, and spatial data from at least one resource; and
an output module for generating an output including at least one insight associated with the at least one of the geographical location, the time date, and the impact event according to the inquiry along with the at least one of event data, time data, and spatial data associated with the analysis of the inquiry.

7. The system of claim 6, wherein the at least one resource is an online database, a website, a social media site, a manual input, a data feed, a city information resource, and a static database

8. The system of claim 6, wherein the impact event is at least one of an agency report, an emergency situation, a closed area, damage to a structure, an accident, a celebration event, a road or location closure, and a parade or other event.

9. The system of claim 6, wherein additional information is obtained by the processor regarding the at least one of the geographical location, the timedate, and the impact event from at least one of: an online news source, a weather source, and a social media source.

10. The system of claim 6, wherein the at least one insight is a constructive notice regarding a fine, a warning, and a mitigating opportunity in view of the impact event.

11. A non-transitory computer readable medium having instructions thereon which can be executed to perform the following method comprising:
receiving by a processor an inquiry by a user regarding at least one of a geographical location, a timedate, and an impact event;
processing the inquiry by a processor, to determine at least one a region of the geographical location, the geographical location at the timedate and a series of times surrounding that timedate, and a location associated with the impact event;
analyzing the inquiry in view of the determinations and obtaining at least one of event data, time data, and spatial data by a processor from at least one resource associated with the analysis of the inquiry; and
generating an output including at least one insight associate with the at least one of the geographical location, the time date, and the impact event according to the inquiry along with the at least one of event data, time data, and spatial data associated with the analysis of the inquiry.

12. The medium of claim 11, wherein the at least one resource is an online database, a website, a social media site, a manual input, a data feed, a city information resource, and a static database

13. The medium of claim 11, wherein the impact event is at least one of an agency report, an emergency situation, a closed area, damage to a structure, an accident, a celebration event, a road or location closure, and a parade or other event.

14. The medium of claim 11, further comprising: providing additional information regarding the at least one of the geographical location, the timedate, and the impact event from at least one of: an online news source, a weather source, and a social media source.

15. The medium of claim 11, wherein the at least one insight is a constructive notice regarding a fine, a warning, and a mitigating opportunity in view of the impact event.
